(19) United States
(12) Patent Application Publication
(10) Pub. No.: US 2025/0078218 A1
(43) Pub. Date: Mar. 6, 2025

(54) FOUR-DIMENSIONAL TESSERACT IMAGE PROCESSING SYSTEM AND METHOD

(71) Applicant: KMB Telematics, Inc., Washington, DC (US)

(72) Inventors: Amro LULU, Washington, DC (US); Marco LA MANNA, Washington, DC (US)

(73) Assignee: KMB Telematics, Inc., Washington, DC (US)

(21) Appl. No.: 18/241,436

(22) Filed: Sep. 1, 2023

(51) Int. Cl. G06T 5/00; G01S 7/282; G01S 13/89

(52) U.S. Cl. CPC G06T 5/73; G01S 7/282; G01S 13/89

(57) ABSTRACT

Described herein are systems and techniques for improving accuracies of determinations made by a sensing device. Distortions created by movement of objects in the field of view of the sensing device may be corrected by performing a series of mathematical operations on sensed data. These mathematical operations may include transforms that convert time domain data into frequency domain data and transforms that convert frequency domain data into phase shift data from which velocities of objects may be identified. These mathematical operations may also be used to identify and correct locations of sensed objects. These transformations may be performed on data associated with a single radar pulse, with a plurality of radar pulses, or on data from one radar pulse that is combined or compared with data of many radar pulses. These radar signals may be transmitted from and received by multiple different independent antennas in a multi-input/multi-output (MiMo) antenna configuration.

### TECHNICAL FIELD

The present disclosure is generally directed to improving the accuracy of data collected by a sensing apparatus. More specifically, the present disclosure relates to improving imaging capabilities of a sensing device.

### BACKGROUND

Sensing apparatuses, such as radio detection and ranging (radar) devices are being used in many different applications today. Radars are deployed in vehicles, drones, aircraft, ships, as well as in other settings. Today there is a growing demand to rely upon sensing devices in autonomous or semi-autonomous vehicles. This means that computers that control these vehicles must be trusted to safely navigate environments without hurting people or damaging property. Even in instances when sensing apparatuses are deployed in environments where personal injury or property damage are not significant risks, any improvement in the way in which these sensing apparatuses perform will provide benefits to those that rely upon those sensing apparatuses to perform tasks.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings in which:

FIG. 1 illustrates a radar imaging system deployed in an environment that collects information in the field of view of the radar imaging system, according to some examples of the present disclosure.

FIG. 2 illustrates an apparatus that may transmit radar signals, receive reflections of those radar signals, and process the transmitted and received radar signals, according to some examples of the present disclosure.

FIG. 3 illustrates components associated with a radar apparatus and functions that may be performed by the radar apparatus, according to some examples of the present disclosure.

FIG. 4 illustrates an array of physical antennas that may be used in a radar apparatus consistent with the present disclosure, according to some examples of the present disclosure.

FIG. 5 illustrates an array of physical antenna elements where a location of a physical antenna element and the locations of a set of respective physical reception antenna elements may be used to identify the locations of a set of respective virtual antenna elements, according to some examples of the present disclosure.

FIG. 6 illustrates a representation of a set of virtual elements of an antenna array that may be used to model received radar signals, according to some examples of the present disclosure.

FIG. 7 illustrates another representation of virtual elements that may be used to model or analyze received radar signals, according to some examples of the present disclosure.

FIG. 8 illustrates a mapping of data in a matrix that includes dimensions of horizontal distance, vertical distance, and velocity, according to some examples of the present disclosure.

FIG. 9 illustrates actions that may be performed by one or more processors that evaluate sensed data when correcting images of objects in the field of view of a radar device, according to some examples of the present disclosure.

FIG. 10 illustrates an example computing device architecture which can be employed to perform any of the systems and techniques described herein.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous features.

In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the present disclosure.

Described herein are apparatus and methods or systems and techniques for improving accuracies of determinations made by a sensing device. Distortions created by movement of objects in the field of view of the sensing device may be corrected by performing a series of mathematical operations on sensed data. These mathematical operations may include transforms that convert time domain data into frequency domain data and transforms that convert frequency domain data into phase shift data from which velocities of objects may be identified. These mathematical operations may also be used to identify and correct locations of sensed objects. These transformations may be performed on data associated with a single radar pulse, with a plurality of radar pulses, or on data from one radar pulse that is combined or compared with data of many radar pulses. These radar signals may be transmitted from and received by multiple different independent antennas in a multi-input/multi-output (MIMO) antenna configuration.

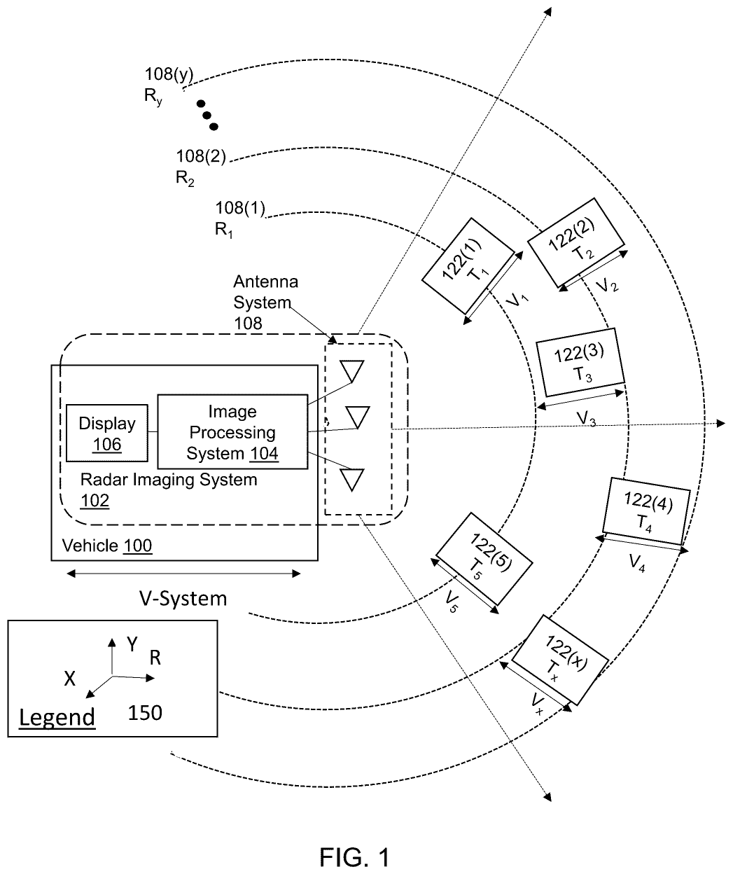

FIG. 1 illustrates a radar imaging system deployed in an environment that collects information in the field of view of the radar imaging system. FIG. 1 includes radar imaging system 102 that is located in vehicle 100. Radar imaging system 102 includes image processing system 104, display 106, and antenna system 108. One or more processors of radar imaging system 102 may control the transmission of radar signals from antenna system 108. Antennas of antenna system 108 may receive reflections of transmitted radar energy after the transmitted radar signals encounter objects in the field of view of a radar imaging system 102. Legend 150 shows that the image processing system 104 may create mappings of spaces around vehicle 100 in an up/down direction along a Y axis, in a left/right (X) along an X axis, and with distance or range R along a third axis. Radar signals that are sent to transmitting elements of an antennal system may be referred to as representations of a modulated radar signal and reflections of that modulated radar signal may be referred to as responses to the representation of the modulated signal.

Once reflections of transmitted radar signals are received, they may be used to generate resultant signals that are sampled such that processors of radar imaging system 102 may identify locations of objects 122(1), 122(2), 122(3), 122(4), 122(5), and 122(x). Each of these objects may be located at different distances from radar imaging system 102. Further, each of these objects may be moving relative to vehicle 100 at different respective velocities V1, V2, V3, V4, and Vx. Distances or ranges from radar imaging system 102 where objects 122(1), 122(2), 122(3), 122(4), 122(5), and 122(x) are located are shown in perspective views, and are located near or between ranges 108(1), 108(2), and 108(x). FIG. 1 also shows that different times T1, T2, T3, T4, T5, and Tx may be associated with detections of objects 122(1), 122(2), 122(3), 122(4), 122(5), and 122(x).

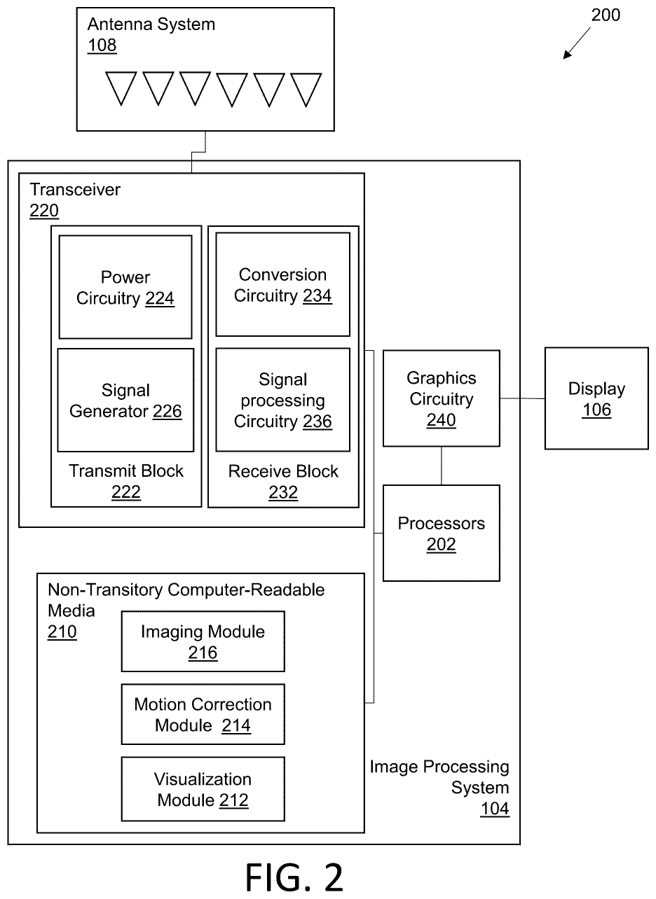

FIG. 2 illustrates an apparatus that may transmit radar signals, receive reflections of those radar signals, and process the transmitted and received radar signals. Apparatus 200 of FIG. 2 includes antenna system 108 that is coupled to transceiver 220 of image processing system 104. Imaging processing system 104 includes memory (non-transitory computer readable media) 210, transceiver 220, processors 202, and graphics circuitry 240. Imaging processing system 104 is also coupled to display 106.

Transceiver 220 includes power circuitry 224, signal generator 226, transmit block 222, conversion circuitry 234, signal processing circuitry 236, and receiver block 232. Power circuitry 224 may be a power supply built from components that convert an available voltage from a power source (e.g., 12-volt automotive battery or alternator) to voltages used by other circuits of transceiver 220 and/or image processing system 104. Signal generator 226 may be a set of circuits that generates signals that are provided to antenna system 108 after those signals are amplified. Signal generator 226 may generate a set of swept frequency signals that are applied to one or more transmission antennas of antenna system 108 based on settings configured by processors 202 via transmit block 222. Processors 202 may configure transmit block 222 to control various operations of signal generator 226. These operations can include setting frequencies used to transmit signals from specific antennas of antenna system 108 and setting the timing of transmitted signals.

When signal generator 226 provides a signal to an antenna of antenna system 108, that signal is transmitted into space near apparatus 200. This transmitted signal may be reflected off an object and back towards apparatus 200 where it may be received via a set of reception antennas of antenna system 108. The received signal may be mixed in real-time or pseudo real-time with the transmitted signal by analog components of conversion circuitry 234 when a resultant signal is generated. This resultant signal may then be sampled by an analog to digital converter (ADC) of signal processing circuitry 236. In certain instances, conversion circuitry 234 and/or signal processing circuitry 236 may perform other tasks of, for example, filtering. Receive block 232 may include a set of registers or a memory accessible by processors 202 that may execute instructions out of memory (non-transitory computer-readable media) 210.

Memory or non-transitory computer readable media 210 may store different sets of instructions that may be organized as visualization module 212, motion correction module 214, and imaging module 216. Processors 202 may execute instructions out of memory 210 when processing data from receive block 232. Instructions of visualization module 212 may be used to generate an initial set of visualization data from sampled data. Instructions of motion correction module 214 may allow processors 202 to make corrections to the initial set of visualization data based on effects caused by motion of an object. Instructions of imaging module 216 may allow processors 202 to generate images or image data from the corrected visualization data. The image data may be provided to display 106 via graphics circuitry 240.

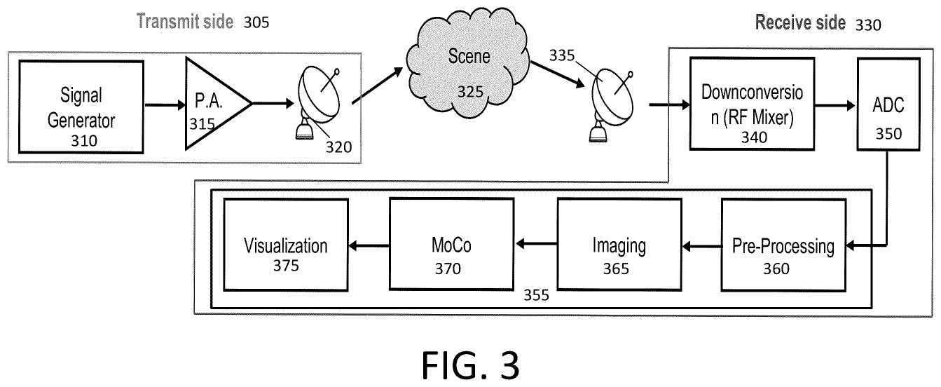

FIG. 3 illustrates components associated with a radar apparatus and functions that may be performed by the radar apparatus. FIG. 3 includes components that may be referred to as transmit side 305 components and other components that may be referred to as receive side 330 components. Components on the transmit side 305 include signal generator 310, power amplifier 315, and transmit antenna 320. As discussed in respect to FIG. 2, a set of signal generator components may allow an apparatus generate signals that are transmitted into space (a scene) 325 near the apparatus. Once a signal is generated by signal generator 310, that signal may be amplified by power amplifier 315, and then that signal may be transmitted into scene 325 via antenna 320.

In operation, signal generator 310 may be operative to generate waveforms to transmit as radar signals via one or more elements of a plurality of antenna elements coupled to the signal generator 310. These antenna elements may be operative to transform the waveforms toward a field of view (e.g., transmit the radar signals into a scene in front of a vehicle) and receive responses of the transformed waveforms from the field of view. This may include transmitting the waveforms as radar signals and receiving reflections of those transmitted radar signals. Signal processing circuitry coupled to the plurality of antenna elements, may be operative to process the responses of the transformed waveforms.

Reflections of that transmitted radar signal may be received by antenna 335. These received signals may be provided to down-conversion (RF mixer or mixer) 340. This mixer 340 may mix the transmitted signal with the received signal when a resultant signal is generated. Two swept frequency signals (a transmitted signal and received signal) that are offset in time may be mixed to generate a resultant signal that has a frequency that varies with range. This resultant signal may then be sampled by ADC 350. One or more processors that execute instructions out of memory 355 may perform functions of pre-processing 360, imaging 365, motion correction (MoCo) 370, and visualization generation 375. Instructions of this pre-processing function 360 may include preparing images to be generated based on the execution of imaging function 365. One pre-processing 360 function that may be performed relates to removing data that may result in falsely detecting the presence of an object. Such false object detections may be associated with a rate of false alarms or a “constant false alarm rate” (CFAR). A false detection or an object or “false alarm” may be caused when a radar signal reflects off numerous objects before being received by a radar device. False detections may also be caused by the presence of noise that may affect receiver circuits. False detections, whether caused by signals that were reflected off of numerous objects or noise each commonly are associated with a relatively low signal amplitude of a returned signal. In order to limit a number of false object detections (false alarms) and to control CFAR, received signals that have less than a threshold reception signal amplitude may be filtered out by pre-processing circuits. In instances when this reception threshold is relatively low (below a threshold level) may result in an increase in false detections and an increase in CFAR. Conversely, in instances when this reception threshold is relatively high (above the first or a second threshold) may result in real objects not being detected. As such, radar designers may select a reception threshold that is at an intermediate level in order to not generate “too many” false alarms while not removing detections associated with real objects. Since this is a difficult task, designers may also dynamically change reception thresholds depending on a probability that may vary based on a signal to noise ratio of a returned signal.

A CFAR may be applied in any dimension, the CFAR may be implemented as a convolution process between a signal and a kernel (e.g., a set of processing code). When a signal is one-dimensional (1D), the kernel may be 1D, when the signal is two-dimensional (2D), the kernel may be 2D. So in in an instance when a four-dimensional (4D) analysis is used, the CFAR may be applied on a set of 4D data with a 4D kernel, and the CFAR may be referred to as a 4D-CFAR. In instances with the CFAR is applied after sampling range and generating 3D-arrays, and the CFAR is generated using a 3D-array kernel, the CFAR may be referred to as a 3D-CFAR. One or more objects identified in the one or more representations of the field of view at a first range may be identified based on thresholds that are adapted based on a calculated CFAR. The number of dimensions that a particular set of processing code (kernel) is configured to process may be used to identify whether a CFAR is a ID, a 2D, a 3D, or a 4D CFAR.

Instructions of pre-processing function 360 and/or imaging function 365 may also be executed by a processor to identify a velocity of an object based on an identified amount of Doppler shift associated with the resultant signal sampled by ADC 350. Data associated with the identified velocity may be used to adjust or correct motion of the object based on a set of motion correction functions 370. Visualizations may then be generated by a processor that executes instructions of visualization function 375.

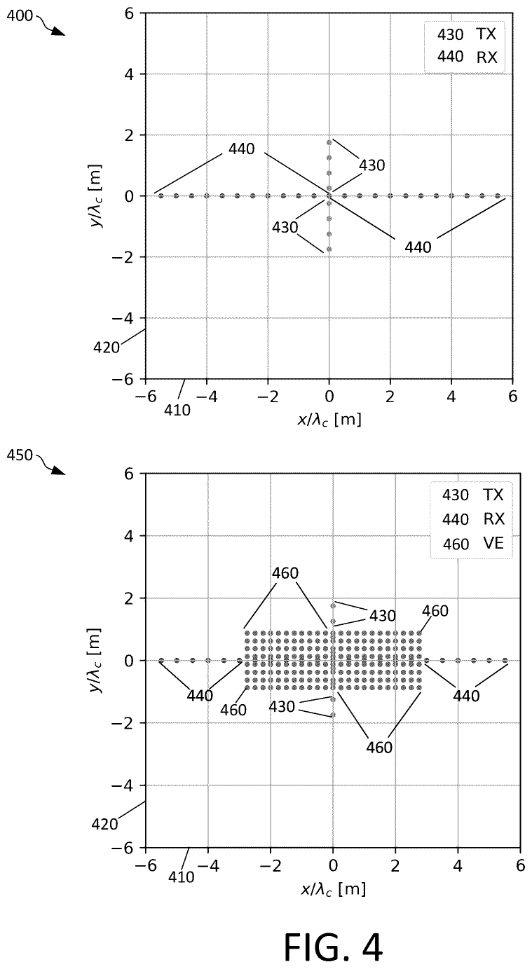

FIG. 4 illustrates an array of physical antennas that may be used in a radar apparatus consistent with the present disclosure. FIG. 4 includes a first map 400 that shows the array of physical antennas (430 & 440) and FIG. 4 includes a second map 450 that shows a set of virtual antennas 460 superimposed over the physical antennas (430 & 440) of map 400. Each of the different antennas illustrated in FIG. 4 are depicted as dots. The antenna array of map 400 includes eight transmit antennas 430 TX and twenty-three reception antennas 440 RX. Map 400 includes a horizontal axis 410 with a scale of x/λc where λc is wavelength of a signal of frequency fc and the character x may refer to a spacing between reception antennas 440. Map 400 also includes vertical axis 420 with a scale y/λc where y may refer to a spacing between transmit antennas 430. A center point of the antenna array in map 400 is located at coordinates (x/λc, y/λc)=(0, 0). Each of the transmit antennas 430 are located along a vertical line of map 400 and each of the reception antennas are located along a horizontal line of map 400.

As mentioned above, map 450 shows a set of virtual antennas 460 superimposed over the physical antennas (430 & 440). The terms “virtual antennas” and “virtual elements” (VE) may be used interchangeably in this disclosure. Map 450 includes horizontal axis 410, vertical axis 420, and all of the physical elements 430 and 440 that were included in map 400. Map 450 also includes virtual elements 460. In operation, a radar device may transmit radar signals from one or more of transmit antennas 440 and may receive reflections of those transmitted signals at one or more reception antennas 440. Signals received by each respective reception antenna 440 may be independently provided to a mixing circuit that may generate a resultant signal by mixing a transmitted signal with a received signal. As discussed in respect to FIG. 3, an ADC may sample the resultant signal such that processors of a radar device can perform different functions on the sampled data.

Representations of data received by the various antennas may correspond to a system that includes more antennas than a radar device actually has. The number of virtual elements in map 450 is one hundred and eighty-four. This corresponds to the product of eight transmit antennas and twenty-three reception antennas. As such, the 31 antennas (eight transmit antennas 430 and twenty-three reception antennas) included in map 400 may be represented as the 184 virtual elements 460 of map 450. Such representations may allow a processor of the radar apparatus to accurately identify the location of a moving object or more accurately resolve an image of that object.

Signals transmitted by transmitter antennas 430 may travel into a scene where the transmitted signals interact with objects in the scene, some of the energy scattered (reflected) by the objects travels back to reception antennas 440. Various types or frequencies of signals or sequences of waveforms may be transmitted by different antennas depending on the mode of operation supported by a radar device. One possible set of configurations may be consistent with MIMO antenna connections. A MIMO antenna configuration may include antennas that are independently controlled. For example, each transmit antenna may be connected to a signal generator via an independent control trace or wire and each reception antenna may be connected to a mixer circuit via an independent trace or wire. In other instances, each of the transmit antennas may be connected to the signal generator and the reception antennas may be connected to the mixer circuit via crossbar switches (e.g., field effect transistors). Such switches may be used to controllably connect one or more transmission antennas to the signal generator and controllably connect one or more reception antennas to the mixer circuit.

Apparatuses of the present disclosure may include multiple physical transmit antennas and multiple physical reception antennas. In certain instances, each of the physical transmit antennas may be controlled independently and each of the physical reception antennas may receive signals independently. Multiple different modes of operation may be supported by a single apparatus. Different modes of operation may include sequentially transmitting pulses of radar signal, transmitting radar signal pulses from all transmit antennas in an antenna array simultaneously, or transmitting radar signal pulses from selected groups of transmit antennas in an antenna array. In certain instances, radar signal pulses may be transmitted from different antennas at different frequencies. Multiple radar carrier frequencies may be used or different swept frequency signals may be used. Examples of transmission techniques that may be used by an apparatus include time division multiplexing (TDM), frequency division multiplexing (FDM), or code division multiplexing (CDM). Signals may be transmitted from one respective antenna with polarizations that are orthogonal with respect to another respective antenna.

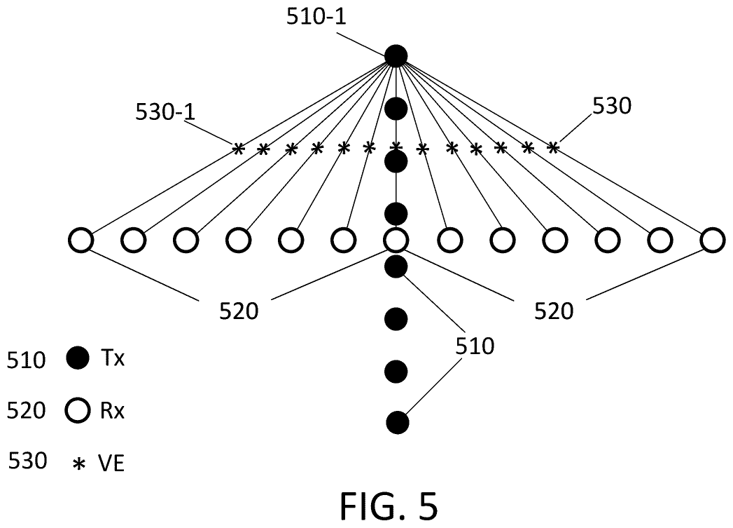

FIG. 5 illustrates an array of physical antenna elements where a location of a physical antenna element and the locations of a set of respective physical reception antenna elements may be used to identify the locations of a set of respective virtual antenna elements. FIG. 5 shows a set of physical transmit antennas 510 that are arranged in a vertical direction and shows the set of physical reception antennas 520 that are arranged in a horizontal direction. Physical transmit antennas 510 are drawn as dark circles and physical reception antennas 520 are drawn as circles that have a dark outer ring and a light-colored center. A set of lines are drawn from the upper physical transmit antenna 510-1 to each respective physical transmit antenna 520, each of these respective lines connects physical transmit antenna 510-1 to one of the physical reception antennas 520. Virtual elements (VE) 530-1, represented as asterisks are located at a midpoint of each of the lines that connect physical transmit antenna 510-1 to each respective physical reception antenna 520. As such, locations of each of the virtual elements in a mapping may be located halfway between a respective physical transmit antenna and a respective physical reception antenna. This process may be used to identify locations of respective virtual elements 460 of FIG. 4.

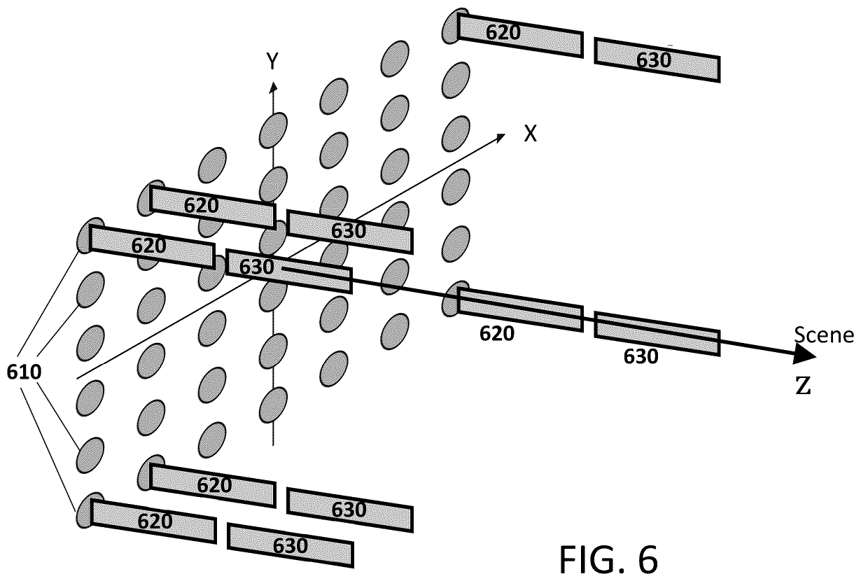

FIG. 6 illustrates a representation of a set of virtual elements of an antenna array that may be used to model received radar signals. The virtual elements 610 of FIG. 6 are illustrated as dark circles that are disposed along a plane formed by the horizontal X axis and the vertical Y axis of FIG. 6. Signals transmitted by transmission elements may be transmitted into a scene (space) in front of virtual elements 610 perpendicular to both the X and Y axes along the Z axis of FIG. 6. Once these signals encounter an object, reflections of those signals may be received at physical receiving elements at a radar device. The elongated gray rectangles 620 & 630 represent reflected radar signals being received by virtual elements 610. Amplitudes, frequencies, and/or durations of a set of transmitted radar signals may be configured based on requirements of a particular application.

A sequence of radar pulse transmissions may include transmitting from selected transmit antennas a sequence of Q radar pulses (or chirps). Signal amplitudes, pulse durations, or number of radar pulses transmitted may be set for a given application. Return signals 620 and 630 may be mixed to generate a resultant signal and that resultant signal may be sampled. Techniques of the present disclosure may be performed using a selected type of radar apparatus, for example, a frequency modulated carrier wave (FMCW) type of radar or a pulsed type of radar may be used.

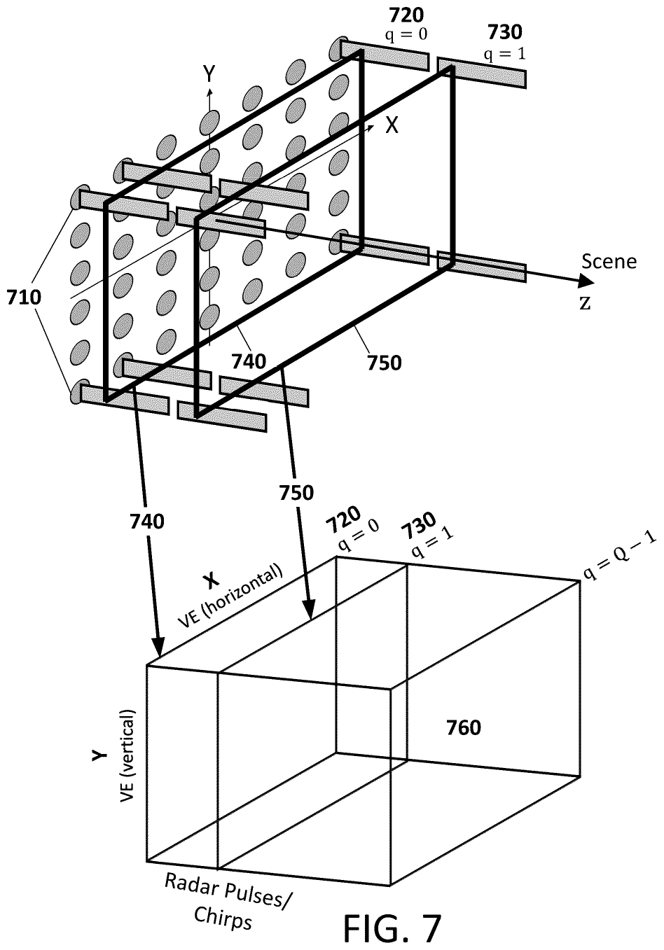

FIG. 7 illustrates another representation of virtual elements that may be used to model or analyze received radar signals. Like FIG. 6, FIG. 7 includes virtual elements, here illustrated as the dark circles 710. Virtual elements 710 are disposed along a plane formed by a horizontal X axis and a vertical Y axis. Signals transmitted by transmission elements may be transmitted into a scene (e.g., the space) in front of virtual elements 710 along the Z axis that is perpendicular to both the X and Y axes. Once these signals encounter an object, reflections of those signals may be received at physical receiving elements of the radar device. Signals that were actually received by these physical antenna may be modeled as being received by virtual elements 710. As such, the elongated gray rectangles 720 & 730 represent reflected radar signals being “virtually received” by virtual elements 710. Each of these reflected radar signals may be associated with a first radar transmitted radar pulse (or chirp) q=1 and a second transmitted radar pulse (or chirp) q=2.

When a reflected signal is received, it may be mixed with a respective transmitted signal to generate a resultant signal. This resultant signal may be sampled after which a fast Fourier transform (FFT) may be applied to the sampled data to identify a frequency of the reflected signal. Since frequency is proportional to range, a distance that separates the object and the radar device can be determined from the frequency of this resultant signal. Such a separation distance is the range of the object (i.e., range). Rectangle 740 represents a snapshot of sampled data associated with a first transmitted radar pulse and a first received radar pulse. This process may be repeated for each radar pulse as shown transmitted by the radar device. Rectangle 750 represents a snapshot of sampled data associated with a second transmitted radar pulse and a second received radar pulse. Because of this, ranges of objects in the field of view of the radar device may be identified for each transmitted radar pulse. This FFT may be referred to as a one-dimensional (1D) FFT because it transforms the dimension of time to the dimension of frequency indicative of range.

Sampled data associated with the acquisition of a received radar pulse may be organized, in the form of a matrix that has multiple dimensions. Matrix 760 includes a horizontal X axis (VE horizontal) dimension, a vertical Y axis (VE vertical) dimension, and a radar pulses/chirps dimension. Radar pulses that are transmitted at different times may be stored in a different snapshot. Snapshots 720 and 730 therefore include data that is a function of time. Because of this, the radar pulses/chirps dimension corresponds to time. Since this sampled data also includes range information, the data of matrix 760 maps information in four dimensions that include the horizontal dimension, the vertical dimension, the distance (or range) dimension, and the radar pulses/chirp (time) dimension.

Any number Q of radar signal pulses or chirps (q=1, q=2 . . . and q=Q−1) may be associated with matrix 760. Matrix 760 of FIG. 7 is represented as a cube that spans a plurality of snapshots of received data. Data of a single snapshot may be referred to as “fast-time” data because it may be limited to timing associated with a single radar pulse. Since data contained within matrix 760 spans timing associated with a plurality of snapshots that are associated with a plurality of radar pulses, data from these plurality of snapshots may be referred to as “slow-time” data. As such, matrix 760 can include a data mapping that spans slow-time over the time (radar pulse/chip) dimension. Matrix 760 can include data discretely associated with respective snapshots or slices 740 and 750 of fast-time data. Each slice 740 and 750 may be associated with a selected range or range span. Data of these matrices may be mapped to or stored in a set of bins that correspond to range, otherwise referred to as range bins. Each range bin may be associated with one or more transmitted radar pulses and with one or more snapshots or slices of acquired data.

The set of data of matrix 760, depending on a selected sequence of transmitted radar pulses, may span hundreds of microseconds. As such, differences in slow-time data as compared to fast-time data may be imperceptible to a human yet not to modern electronic equipment. Because of this, one or more processors executing instructions out of a memory can perform techniques of the present disclosure from fast-time data or slow-time data or combinations thereof when a human cannot. After the data of matrix 760 is collected, another transform may be performed to convert time related data into frequency related data. This may include applying a transform along the radar pulses/chirps (or time) dimension using sets of slow-time data to identify a velocity of an object. Alternatively of additionally, this second transform may be applied to data from a single slice of fast-time data to identify the velocity of the object.

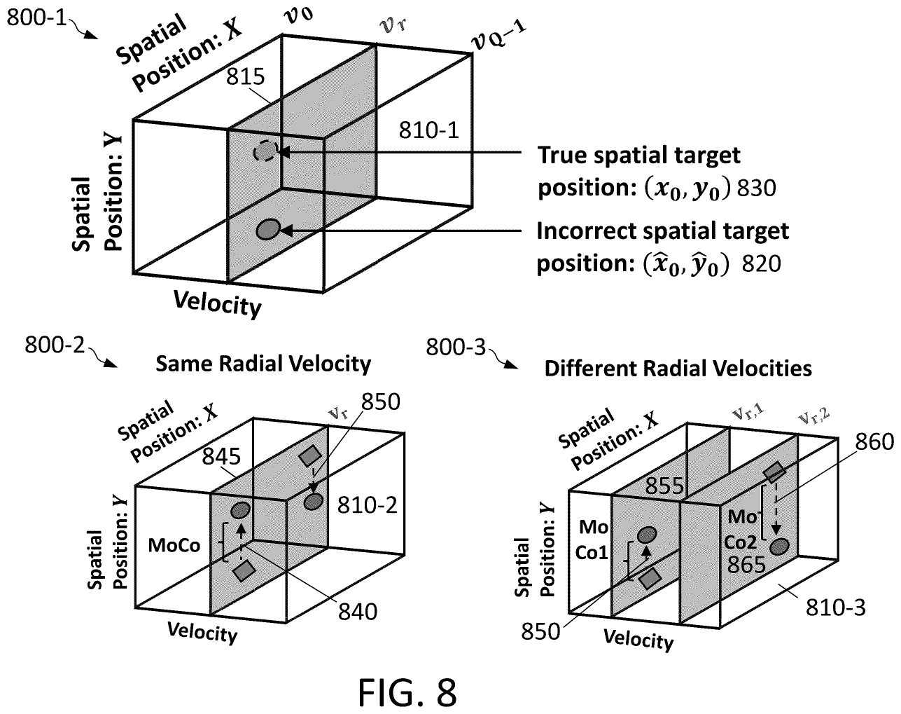

FIG. 8 illustrates a mapping of data in a three-dimensional (3D) array that includes dimensions of horizontal distance, vertical distance, and radial velocity. Since collected data also includes range information, the 3D-arrays of FIG. 8 may be considered a range-cut of a four-dimensional (4D) tesseract and data contained within such 3D-arrays may be used to compensate for the effects of Doppler shift. This 4D tesseract may store data associated with multiple dimensions that include range dimension R, horizontal spatial dimension information X, vertical spatial dimension information Y, and radial velocity dimension V.

FIG. 8 includes a first representation 800-1, a second representation 800-2, and a third representation 800-3. Representation 800-1 includes 3D-array 810-1, representation 800-2 includes 3D-array 810-2, and representation 800-3 includes 3D-array 810-3. Data stored in these 3D-arrays 810-1, 810-2, and 810-3 may be associated with a spatial position in the X dimension, a spatial position in the Y dimension, and a radial velocity dimension as shown by the edges of the 3D-arrays 810-1, 810-2, and 810-3. The data of 3D-arrays 810-1, 810-2, and 810-3 may be obtained by performing 3D transforms (or 3D FFTs). For example, a 3D fast Fourier transform may include a combination of a two-dimensional (2D) inverse FFT (IFFT) and a one-dimensional (1D) FFT on data from cube 760 of FIG. 7. This process may be used to generate data of 3D-arrays 810-1, 810-2, and 810-3. Data associated with a particular radial velocity (e.g., Vr of 3D-array 810-1) may form radial velocity slice 815 of data that describes locations of objects in the field of view of a radar device that are moving at radial velocity Vr. All objects (or targets) within any slice of 3D-arrays 810-1, 810-2, and 810-3 may have the same range R and objects within a same slice (e.g. slice 815) have a same radial velocity. Each respective 3D-array of FIG. 8 includes one or more slices that are illustrated as gray squares. 3D-array 810-1 includes slice 815, 3D-array 810-2 includes slice 845, and 3D-array 810-3 includes slices 855 and 865.

Processors that perform the transforms on data may store the results of these transforms in a format that associates horizontal position, vertical position, and velocity. Representation 800-1 shows a single object that has radial velocity of Vr at an initial location in slice 815 of 3D-array 810-1. This initial location may be identified as being at coordinates (\hat{x}₀, ŷ₀). Coordinates (\hat{x}₀, ŷ₀) may not really be correct, however, as motion effects may have distorted the actual location of the object. Representation 800-1 shows that the actual location (e.g., the true spatial target position 830) of the object is located at coordinates (x₀, y₀). Because of this, coordinates (\hat{x}₀, ŷ₀) may be referred to as incorrect spatial target position 820. Matrix 810-1 also includes radial velocities of V₀ and V_{Q-1} that each may be associated with a different set of data. In certain instances, the terms “target” and “object” may be used interchangeably as the term “target” is commonly used in radar applications. By calculating the true spatial target position, the effects of Doppler shift may be removed. As such, spatial data may be decoupled from doppler data by removing the effects of Doppler shift.

The second representation 800-2 of FIG. 8 illustrates an instance where effects of Doppler shift may be compensated for in an instance when two different objects each have a same radial velocity Vr. Since these two objects have a same radial velocity, they are both located within slice 845 of 3D-array 810-2. Motion correction algorithms may access collected data when compensating for motion related effects such that motion correction (MoCo) of a first object and a second object may be corrected as indicated by the arrowed lines 840 and 850 in representation 800-2. An initial location of the object may be adjusted based on the radial velocity Vr of the two different objects in representation 800-2.

The third representation 800-3 of FIG. 8 illustrates an instance where Doppler shift may be compensated for when two different objects have different radial velocities Vr,1 and Vr,2. Since these two different objects have different velocities, they appear in two different slices (slice 855 and slice 865) of 3D-array 810-3. Spatial filtering may be applied within velocity slices (V-slices) around detected targets/objects. This spatial filtering may be performed in order to eliminate or reduce possible leakage from some targets/objects appearing at neighboring V-slices. Motion correction algorithms may access collected data when compensating for motion related effects of radial velocity Vr,1 of a first object and may access collected data when compensating for motion related effects of radial velocity Vr,2 of a second object. A first set of motion correction calculations (MoCo1) of the first object and a second set of motion correction calculations of the second object (MoCo2) may be performed such that locations of the first and the second object may be corrected as indicated by the lines 860 and 870 of representation 800-3. In certain instances, the object with velocity Vr,1 may be located at a same range as the object with velocity Vr,2. In such an instance, data stored in a same range bin may be accessed when motion is corrected for these objects.

Correcting the motion may require making a series of calculations. For example, calculations may be performed that associate data from multiple antennas of a MIMO antenna array that receive reflections of signals at different times. Time division multiplexing (TDM) may allow data associated with specific transmitted signals that are received by different antenna elements at different times to be processed. For each radar chirp, q=0 through Q=Q−1, and each virtual element (VE) of an antenna array (e.g. virtual elements 460 of FIG. 4), a target response may be identified. The terms ϑ_{q} and ϑ₀ below may be values used to correct phase associated with a target, as such they may be referred to as correction phase values, where α_{q}e^{jϑ}^{_{q}}, q=0, . . . , Q−1:
1) If the target is static, ϑ_{q}=ϑ₀, ∀q
2) If the target is moving ϑ_{q} is different for every q

To properly image a target and exploit a coherent interval, one needs to compensate ϑ_{q}→ϑ₀, q=1, . . . , Q−1. Consider the MIMO array from the previous slides with the Txs ordered as shown. Considering T₀, all the VE on a first (from top) row, “see” the q=0, . . . , Q−1 chirps. Considering T₁, all the VE on a second (from top) row, “see” the q=Q, . . . , 2Q−1 chirps. Given the specific radial velocity, the VEs on each row of the raw data matrix to be shifted by

$$γ ( l , m ) = {e}^{- j 2 π 2 \frac{{f}_{c}}{c} {v}_{r} {lQT}_{c}} .$$

As described above, the data of 3D-arrays may have been identified by performing a 2D IFFT and combining results of that 2D IFFT with results of a 1D FFT. This data may be identified using a three-dimensional (3D) FFT instead.
Alternatively, it is also possible to:
   First apply a 2D FFT along fast-time (range domain) and slow-time (chirp domain). This may include performing transforms on data from multiple different ranges.
   Then apply a 2D IFFT along the VE horizontal (l) and VE vertical (m) dimensions.
   This is because Fourier transform operations are linear, as such, an order in which the transforms are performed does not matter. As long as the operations are applied over different dimensions, the set of transforms should generate valid results.
Overall, 4 FFT operations may be performed to generate the 4D (R, x, y, v) tesseract.

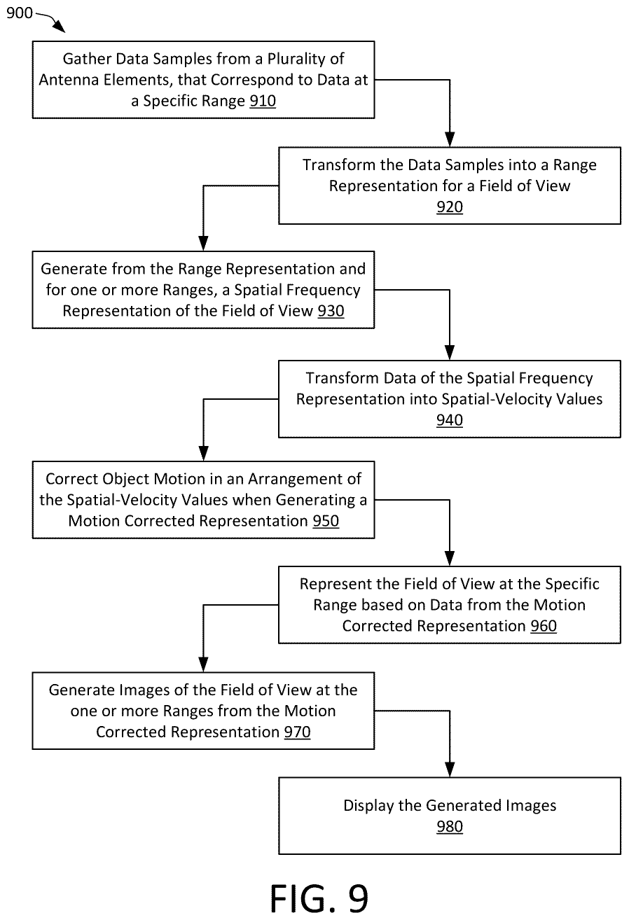

FIG. 9 illustrates actions that may be performed by one or more processors that evaluate sensed data when correcting images of objects in the field of view of a radar device. Block 910 of FIG. 9 is where samples associated with particular antenna elements of a plurality of antenna elements may be gathered. Here again, when a signal is received by an antenna element, that received signal may be mixed with a transmitted signal to generate a resultant signal that is sampled by an analog to digital converter (ADC).

Since the range to an object corresponds to the frequency of the resultant signal, a transform may be performed at block 920 to identify the frequency of the resultant signal. From this frequency, the range to the object may be identified. As discussed above, this transform may be a first FFT that converts time domain data into frequency domain data. Furthermore, FFTs may be performed at block 920 on data associated with signals received via different antenna elements to identify ranges to objects that are located in the field of view of the radar apparatus. As such, operations performed at block 920 may transform data samples into discrete range representations of objects in the field of view of the radar device.

At block 930, data of the range representations generated at block 920 may be evaluated when a spatial-frequency representation is generated. This spatial-frequency representation may associate for each range of one or more ranges, locations of one or more objects with frequency data generated at block 920. This frequency data may include information from which a phase shift of the resultant signal may be identified, to quantify this, another transform may be performed on the frequency data to identify values of phase shift at block 940. From the phase shift values identified at block 940, values of velocity for each of the one or more objects in the field of view of the radar apparatus may be identified. The transformation performed at block 940 may transform the spatial frequency representation generated at block 930 into data that identifies spatial-velocity values for each of the one or more objects in the field of view of the radar apparatus. These spatial-velocity values may include range values and velocity values of an object.

A motion correction function may be initiated at block 950. This motion correction function may perform mathematical operations that account for object velocity to generate corrected images of the one or more objects. At block 960, data from the motion correction function may be used to generate a representation of the field of view of the radar device at the specific range such that a corrected view of an object associated with that specific range can be generated. Based on this, a corrected image of the object at the specific range may be generated at block 970 after which those images may be displayed on a display at block 980. In certain instances, corrected data may be used by other processes performed by equipment associated with a radar apparatus.

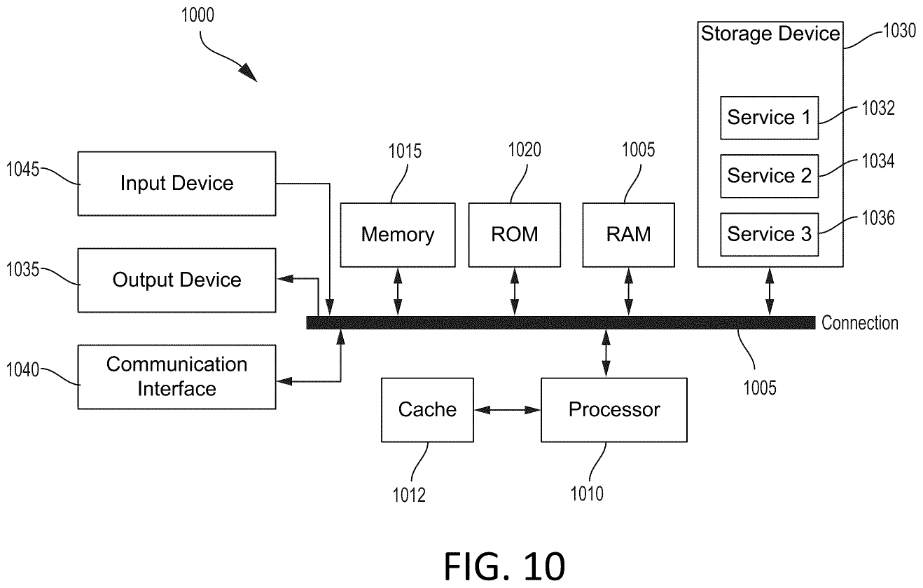

FIG. 10 illustrates an example computing device architecture which can be employed to perform any of the systems and techniques described herein. In some examples, the computing device 1000 architecture can be integrated with tools described herein. The components of the computing device architecture 1000 are shown in electrical communication with each other using a connection 1005, such as a communication bus. The example computing device architecture 1000 includes a processing unit (CPU or processor) 1010 and a computing device connection 1005 that couples various computing device components including the computing device memory 1015, such as read only memory (ROM) 1020 and random access memory (RAM) 1025, to the processor 1010.

The computing device architecture 1000 can include a cache of high-speed memory connected directly with, in close proximity to, or integrated as part of the processor 1010. The computing device architecture 1000 can copy data from the memory 1015 and/or the storage device 1030 to the cache 1012 for quick access by the processor 1010. In this way, the cache can provide a performance boost that avoids processor 1010 delays while waiting for data. These and other modules can control or be configured to control the processor 1010 to perform various actions. Other computing device memory 1015 may be available for use as well. The memory 1015 can include multiple different types of memory with different performance characteristics. The processor 1010 can include any general-purpose processor and a hardware or software service, such as service 1 1032, service 2 1034, and service 3 1036 stored in storage device 1030, configured to control the processor 1010 as well as a special-purpose processor where software instructions are incorporated into the processor design. The processor 1010 may be a self-contained system, containing multiple cores or processors, a communication bus, memory controller, cache, etc. A multi-core processor may be symmetric or asymmetric.

To enable user interaction with the computing device architecture 1000, an input device 1045 can represent any number of input mechanisms, such as a microphone for speech, a touch-sensitive screen for gesture or graphical input, keyboard, mouse, motion input, speech and so forth. An output device 1035 can also be one or more of a number of output mechanisms known to those of skill in the art, such as a display, projector, television, speaker device, etc. In some instances, multimodal computing devices can enable a user to provide multiple types of input to communicate with the computing device architecture 1000. The communications interface 1040 can generally govern and manage the user input and computing device output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof. The storage device 1030 can include services 1032, 1034, 1036 for controlling the processor 1010. Other hardware or software modules are contemplated. The storage device 1030 can be connected to the computing device connection 1005. In one aspect, a hardware module that performs a particular function can include the software component stored in a computer-readable medium in connection with the necessary hardware components, such as the processor 1010, connection 1005, output device 1035, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An image processing system comprising:
a memory storing computer-program instructions;
one or more processors coupled to the memory that execute the computer-program instructions to:
gather data samples associated with a plurality of antenna elements, wherein the data samples correspond to data at a specific range;
transform the data samples into a range representation for a field of view;
sample the range representation at each range of one or more ranges within the field of view to obtain a spatial frequency representation of the field of view;
transform the spatial frequency representation to obtain spatial-velocity values for the field of view;
perform motion correction on one or more targets in an arrangement of spatial-velocity values to generate a motion corrected representation of the field of view; and
generate from the motion corrected representation of the field of view, a representation of the field of view at the specific range.

2. The image processing system of claim 1, wherein the plurality of antenna elements are arranged in a multi-input multi-output (MIMO) configuration.

3. The image processing system of claim 1, wherein the plurality of antenna elements includes a plurality of reception antennas.

4. The image processing system of claim 1, wherein the one or more ranges correspond to reflections from respective objects located at the one or more ranges.

5. The image processing system of claim 1, wherein the one or more processors are configured to render the field of view at the one or more ranges based on data of the motion corrected representation.

6. The image processing system of claim 1, wherein the one or more processors execute the computer-program instructions to:
perform a summation on data of the motion corrected representation of the field of view to generate one or more images of the field of view at the specific range.

7. The image processing system of claim 6, wherein the summation comprises a coherent summation on the motion corrected representation of the field of view.

8. The image processing system of claim 6, wherein the one or more images comprise one or more two-dimensional (2D) images of the field of view.

9. The image processing system of claim 1, wherein one or more ranges comprise a plurality of ranges.

10. The image processing system of claim 1, wherein the data samples comprise samples of a modulated radar signal.

11. The image processing system of claim 10, wherein the modulated radar signal comprises a time modulated radar signal or a frequency modulated radar signal.

12. The image processing system of claim 10, wherein the modulated radar signal comprises a time domain multiplexed (TDM) modulated radar signal or a frequency division multiplexing (FDM) modulated radar signal.

13. The image processing system of claim 1, further comprising an analog to digital converter that samples the data samples associated with the plurality of antenna elements when a first set of data samples are generated.

14. The image processing system of claim 1, wherein signals associated with the plurality of antenna elements are sampled to generate a plurality of data samples at a plurality of ranges.

15. The image processing system of clam 1, wherein the one or more processors execute the computer-program instructions to:
arrange data samples for each range of the one or more ranges along the one or more spatial dimensions to generate one or more first representations of the field of view at the one or more ranges.

16. The image processing system of clam 15, wherein the one or more first representations comprise one or more first data cubes of the field of view at the one or more ranges.

17. The image processing system of clam 1, wherein the one or more processors execute the computer-program instructions to:
arrange the velocity values for each range of the one or more ranges along the one or more spatial dimensions to generate one or more second representations of the field of view at the one or more ranges.

18. The image processing system of claim 17, wherein the one or more second representations comprise one or more second data cubes of the field of view at the one or more ranges.

19. The image processing system of clam 17, wherein the one or more processors execute the computer-program instructions to:
identify one or more targets in the one or more second representations of the field of view at the first range.

20. The image processing system of claim 19, wherein the one or more objects identified in the one or more second representations of the field of view at the first range are identified based on an adaptive threshold.

21. The image processing system of claim 19, wherein the one or more objects identified in the one or more second representations of the field of view at the first range are identified based on a CFAR.

22. The image processing system of claim 21, wherein the CFAR is a three-dimensional (3D) CFAR.

23. The image processing system of claim 1, wherein the transform comprises a fast Fourier transform (FFT).

24. The image processing system of claim 23, wherein the FFT is a three-dimensional (3D) FFT.

25. The image processing system of claim 1, wherein the motion correction is performed by decoupling spatial data from Doppler data.

26. The image processing system of claim 1, wherein the motion correction is performed by decoupling spatial data from Doppler data by decoupling the velocity values from the one or more spatial dimensions orthogonal to a first range.

27. A system comprising:
a signal generator comprising an oscillator configured to generate a modulated signal;
a plurality of antennas elements coupled to the signal generator, wherein the plurality of antennas elements are configured to transmit a representation of the modulated signal;
an image processing system coupled to the plurality of antennas elements, wherein the image processing system is configured to:
gather data samples from a plurality of antennas elements, wherein the data samples correspond to data at a specific range;
transform the data samples into a range representation for a field of view;
sample the range representation at each range of one or more ranges within the field of view to obtain a spatial frequency representation of the field of view;
transform the spatial frequency representation to obtain spatial-velocity values for the field of view;
perform motion correction on one or more targets in an arrangement of spatial-velocity values to generate a motion corrected representation of the field of view; and
generate a representation of the field of view at the specific range based on the motion corrected representation of the field of view.

28. The system of claim 27, further comprising:
one or more pre-processing units configured to generate the data samples from responses to the representation of the modulated signal.

29. A method comprising:
gathering data samples from a plurality of antenna elements, wherein the data samples correspond to data at a specific range;
transforming the data samples into a range representation for a field of view;
sampling the range representation at each range of one or more ranges within the field of view to obtain a spatial frequency representation of the field of view;
transforming the spatial frequency representation to obtain spatial-velocity values for the field of view;
performing motion correction on one or more targets in an arrangement of spatial-velocity values to generate a motion corrected representation of the field of view; and
representing the field of view at the specific range based on the motion corrected representation of the field of view to represent the field of view at the specific range.

30. A system comprising:
a signal generator operative to generate one or more waveforms;
a plurality of antenna elements coupled to the signal generator, wherein the plurality of antenna elements are operative to:
transform the one or more waveforms toward a field of view and receive data based on the one or more waveforms from the field of view;
signal processing circuitry coupled to the plurality of antenna elements, wherein the signal processing circuitry is operative to process the data based on the one or more waveforms from the field of view;
an image processing system coupled to the plurality of antenna elements, wherein the image processing system comprises:
memory storing computer-program instructions;
one or more processors coupled to the memory and, using the computer-program instructions, operative to:
transform samples of the data based on the one or more waveforms into a range representation for the field of view a specific range;
generate a motion corrected representation of one or more targets in the field of view at the specific range using a spatial frequency representation of the field of view, wherein the spatial frequency representation is based on the range representation;
represent the field of view at the specific range based on the motion corrected representation represent the field of view at the specific range;
graphics circuitry coupled to the image processing system, wherein the graphic circuitry is operative to generate one or images of the field of view at the specific range using the motion corrected representation; and
a display coupled to the graphic circuitry, wherein the display is configured to display the one or more images of the field of view at the specific range.

31. A system comprising:
a signal generator operative to generate one or more waveforms;
a plurality of antenna elements coupled to the signal generator, wherein the plurality of antenna elements are operative to transform the one or more waveforms toward a field of view and receive responses of transformed one or more waveforms from the field of view;
signal processing circuitry coupled to the plurality of antenna elements, wherein the signal processing circuitry is operative to process the responses of the transformed one or more waveforms from the field of view;
an image processing system coupled to the plurality of antenna elements, wherein the image processing system comprises:
memory storing computer-program instructions;
one or more processors coupled to the memory and, using the computer-program instructions, operative to:
gather data samples from the plurality of antennas elements, wherein the data samples correspond to data at a specific range;
transform the data samples into a range representation for a field of view;
sample the range representation at each range of one or more ranges within the field of view to obtain a spatial frequency representation of the field of view,
transform the spatial frequency representation to obtain spatial-velocity values for the field of view,
perform motion correction on one or more targets in an arrangement of spatial-velocity values to generate a motion corrected representation of the field of view, and
represent the field of view at the specific range based on the motion corrected representation of the field of view;
graphics circuitry coupled to the image processing system, wherein the graphic circuitry is operative to generate one or images of the field of view at the one or more ranges using the motion corrected representation;
a display coupled to the graphic circuitry, wherein the display is configured to display the one or more images of the field of view at the one or more ranges.

32. An image processing system comprising:
memory storing computer-program instructions;
one or more processors coupled to the memory and, using the computer-program instructions, operative to:
transform samples of data sampled from a plurality of antennas elements at a specific range into range representation for the field of view a specific range;
generate a motion corrected representation of one or more targets in the field of view at the specific range using a spatial frequency representation of the field of view, wherein the spatial frequency representation is based on the range representation;
use the motion corrected representation represent the field of view at the specific range;
render the field of view at the specific range using the motion corrected representation.

33. A method comprising:
gathering data samples associated with a plurality of antenna elements, wherein the data samples correspond to data at a specific range;
transforming the data samples into a range representation for a field of view;
sampling the range representation at each range of one or more ranges within the field of view to obtain a spatial frequency representation of the field of view;
transforming the spatial frequency representation to obtain spatial-velocity values for the field of view;
performing motion correction on one or more targets in an arrangement of spatial-velocity values to generate a motion corrected representation of the field of view; and
generating from the motion corrected representation of the field of view, a representation of the field of view at the specific range.

34. The method of claim 33, wherein the plurality of antenna elements are arranged in a multi-input multi-output (MIMO) configuration.

35. The method of claim 33, wherein the plurality of antenna elements includes a plurality of reception antennas.

36. The method of claim 33, wherein the one or more ranges correspond to reflections from respective objects located at the one or more ranges.

37. The method of claim 33, wherein the one or more processors are configured to render the field of view at the one or more ranges based on data of the motion corrected representation.

38. The method of claim 33, further comprising performing a summation on data of the motion corrected representation of the field of view to generate one or more images of the field of view at the specific range.

39. The method of claim 38, wherein the summation comprises a coherent summation on the motion corrected representation of the field of view.

40. The method of claim 38, wherein the one or more images comprise one or more two-dimensional (2D) images of the field of view.

41. The method of claim 33, wherein one or more ranges comprise a plurality of ranges.

42. The method of claim 33, wherein the data samples comprise samples of a modulated radar signal.

43. The method of claim 42, wherein the modulated radar signal comprises a time modulated radar signal or a frequency modulated radar signal.

44. The method of claim 42, wherein the modulated radar signal comprises a time domain multiplexed (TDM) modulated radar signal or a frequency division multiplexing (FDM) modulated radar signal.

45. The method of claim 33, further comprising sampling the data samples associated with the plurality of antenna elements when a first set of data samples are generated.

46. The method of claim 33, wherein signals associated with the plurality of antenna elements are sampled to generate a plurality of data samples at a plurality of ranges.

47. The method of claim 33, further comprising arranging data samples for each range of the one or more ranges along the one or more spatial dimensions to generate one or more first representations of the field of view at the one or more ranges.

48. The method of claim 47, wherein the one or more first representations comprise one or more first data cubes of the field of view at the one or more ranges.

49. The method of claim 33, further comprising arranging the velocity values for each range of the one or more ranges along the one or more spatial dimensions to generate one or more second representations of the field of view at the one or more ranges.

50. The method of claim 49, wherein the one or more second representations comprise one or more second data cubes of the field of view at the one or more ranges.

51. method of claim 49, further comprising identifying one or more targets in the one or more second representations of the field of view at the first range.

52. The method of claim 51, wherein the one or more objects identified in the one or more second representations of the field of view at the first range are identified based on an adaptive threshold.

53. The method of claim 51, wherein the one or more objects identified in the one or more second representations of the field of view at the first range are identified based on a CFAR.

54. The method of claim 53, wherein the CFAR is a three-dimensional (3D) CFAR.

55. The method of claim 33, wherein the transform comprises a fast Fourier transform (FFT).

56. The method of claim 55, wherein the FFT is a three-dimensional (3D) FFT.

57. The method of claim 33, wherein the motion correction is performed by decoupling spatial data from Doppler data.

58. The method of claim 33, wherein the motion correction is performed by decoupling spatial data from Doppler data by decoupling the velocity values from the one or more spatial dimensions orthogonal to a first range.
